(19) United States
(12) Patent Application Publication
(10) Pub. No.: US 2006/0059755 A1
(43) Pub. Date: Mar. 23, 2006

(54) Suspension-type file folder and index tab system

(76) Inventors: Line Valade, Ste-Therese (CA); Andre Lafleur, Boucherville (CA)

Correspondence Address: FAY KAPLUN & MARCIN, LLP, 15O BROADWAY, SUITE 702, NEW YORK, NY, 10038, US

(21) Appl. No.: 11/231,394

(22) Filed: Sep. 20, 2005

(30) Foreign Application Priority Data
Sep. 21, 2004 (CA) 2,479,516

(51) Int. Cl. G09F 23/10

(52) U.S. Cl. 40/641

(57) ABSTRACT

The present invention is concerned with a suspension-type file folder that may include label holding clamping index tabs. The file folder is so designed as to enable a user to insert and retrieve documents or files in the folder from a side thereof in a side-loading mode of operation, which provides storage space savings and simplifies file cabinet structures. Therefore, index tabs are designed for attachment to either sides of the file folder.

### FIELD OF THE INVENTION

The present invention generally relates to suspension-type file folders. More specifically, the present invention is concerned with an all-polymer file folder and index tab system for use in side loading file cabinets or like file folder suspension systems.

### BACKGROUND OF THE INVENTION

Suspension-type file folders have been well known for many years and are used in combination with file cabinets to provide practical systems for storing and retrieving files and documents. Most suspension-type file folder systems are designed for top loading of files and documents and comprise index tabs that can be removably attached to an upper portion of the folders to help users find documents easily. An example of such a system is disclosed in U.S. Pat. No. 4,053,057 (Snowden—Oct. 11, 1977—Oxford Pendaflex Canada Ltd) wherein a removable index tab designed to hold a user prepared label is provided, which can be attached at different positions along the upper edge of the folder, thus providing good visibility of indexing information. Different indexing tabs of that type exist on the market and a lot of them are already in use in offices or the like dealing with document storage management. However, most label holding index tabs allow use of labels of relatively standard or similar size and dimensions. Therefore, a huge quantity of user prepared labels of relatively standard dimensions are currently in use in the many top loading suspension-type filing systems already installed in the field.

Loading documents in suspended folders from the top in file cabinet drawers or the like presents a limitation in the number of files that can be stored in superposition for a given ceiling height. Therefore, side loading (lateral) filing systems have been introduced, which allow reduction of vertical spacing between shelves as well as addition of shelves closer to ceiling level, leading to increased storage capacity per volume. Resulting potential space savings should incite more and more users to turn to that type of filing systems in the future. Nevertheless, side loading filing systems present two principal challenges: preventing accelerated wear of a bottom portion proximal to the side edges of the suspended folders usually made from cardboard, and providing indexing information readable from the side edge of the files folders.

Currently, some users dealing with very large quantities of files such as hospitals, medical cabinets and libraries already use side loading filing systems. Usually no suspended folders are used, the files (cardboard portfolios) being successively aligned side-by-side directly on shelves provided with separators, and file indexing is typically accomplished through direct coding of individual files by application of numerical and/or color coded labels to a built-in tab provided on a side edge of the specially designed cardboard files (portfolios, folders). U.S. Pat. No. 4,749,121 (Barber—Jun. 7, 1988—Datafile Ltd) provides an example of such a file indexing system, and U.S. Pat. No. 4,580,815 (Barber—Apr. 8, 1986—Datafile Ltd) provides an add-on tab mounted to a side edge of a file folder to enable application of index labels. However, such systems present very limited flexibility as to the type of indexing information that can be applied to the tabs and the possibility of changing that information.

U.S. Pat. No. 4,294,028 (Remond—Oct. 13, 1981—Etablissements F. Nicollet & Cie SA) provides a wear resistant suspension-type folder in combination with a side edge index label holding bracket. Heavy gauge or folded cardboard or a plastic web is used to provide superior wear resistance. A plastic bracket is assembled on a side edge of the folder and can hold a replaceable narrow elongated label. Such folders are available on the European market under the “L'Oblique” trademark. Although this combination suspended file folder provides a reasonably durable and flexible system, its complex structure and assembly make it very expensive. Furthermore, the index label format does not fit that of index tabs widely used with top loading suspended folders, which prevents a user from converting a top loading type filing system to a side loading type without having to create new labels. Also, this system does not allow the use of the standard alphanumeric and chromatic self adhesive index labels and the fixed brackets do not allow positioning of index information at different heights along the edge so as to improve visibility.

Although the above examples show that some suspension-type side loading file folder systems have been contemplated in the prior art, these systems and devices are nevertheless lacking important features necessary for them to provide adequate solutions to the challenges presented by accelerated wear and laterally readable indexing.

It would therefore be a significant advance in the art of suspension-type filing systems to provide a simple wear resistant suspended file folder system which can be advantageously used in side loading file cabinets, while providing highly flexible laterally readable indexing, using removable and adjustable tabs for holding regular size index labels or receiving standard pre-printed self adhesive coded index labels.

### OBJECTS OF THE INVENTION

An object of the present invention is therefore to provide an improved suspension-type file folder and index tab system.

### SUMMARY OF THE INVENTION

More specifically, in accordance with the present invention, there is provided a suspension-type file folder comprising:

a web, folded along a medial line to form two attached covers, each cover having a top edge and two longitudinally spaced apart side edges; each cover defining a bottom portion and a top portion; the bottom portion being longitudinally larger than the top portion; a series of perforations are provided through the web along and proximate the bottom portion of at least one of the two side edges; and

two longitudinally elongated flat suspension rail assemblies, one of the rail assembly being mounted to the top edge of the first cover, and the other rail assembly being mounted to the top edge of the second cover;

wherein the difference in longitudinal size between the top and bottom portions of the covers offers an opening on the top portion such that a side loading mode of inserting and retrieving documents to and from the suspension-type file folder can be achieved.

According to yet another aspect of the present invention, there is provided a removable index tab, for suspension-type file folders provided with an edge having perforations, the removable index tab comprising:

a longitudinal base plate, having a first file contacting surface; and

one clamping tab having a second file contacting surface; the clamping tab being so associated with the longitudinal base plate that the second file contacting surface faces the first file conctacting surface; at least one of the first and second file contacting surfaces being provided with at least one ridge so configured and sized as to enter perforations of the file folder, thus providing positive attachment of the removable index tab onto the suspension-type file folder.

It is to be noted that the expression “side loading” is to be construed herein and in the appended claims as a filing method whereby files or documents stored into a suspended folder are intended to be inserted in the folder and withdrawn therefrom through openings defined by the side edges thereof through a substantially horizontal motion.

It is also to be noted that the expression “documents” used herein and in the appended claims is to be construed as meaning conventional documents and other small objects that may fit into a file folder.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is an isometric exploded view of the suspension-type file folder and index tab system according to an embodiment of the present invention;

FIG. 2-A is a frontal isometric view of a label holding clamping index tab according to an aspect of the present invention;

FIG. 2-B is a top view of the label holding clamping index tab of FIG. 2-A;

FIG. 2-C is a bottom view of the label holding clamping index tab of FIG. 2-A;

FIG. 2-D is a side elevation view of the label holding clamping index tab of FIG. 2-C, shown in an open position;

FIG. 2-E is a side elevation view of the label holding clamping index tab of FIG. 2-C, shown in a closed position;

FIG. 2-F is a transversal cross sectional view of the label holding clamping index tab, taken along line 2F-2F of FIG. 2-C;

FIG. 2-G is a transversal cross sectional view of the label holding clamping index tab, taken along line 2G-2G of FIG. 2-C;

FIG. 3-A, is a frontal isometric view of a stick-on index tab according to an aspect of the present invention;

FIG. 3-B is a top view of the stick-on index tab of FIG. 3-A;

FIG. 3-C is a bottom view of the stick-on index tab of FIG. 3-A;

FIG. 3-D is an end view of an handle side of the stick-on index tab of FIG. 3-A;

FIG. 3-E is a side elevation view of the stick-on index tab of FIG. 3-C;

FIG. 4-A is a front elevation view of an inner face of a suspension rail according to an aspect of the present invention;

FIG. 4-B is a frontal view of an outer face of a suspension rail according to an aspect of the present invention;

FIG. 4-C is an enlarged cross sectional view taken along line 4C-4C of FIG. 4-A;

FIG. 4-D is an enlarged cross sectional view taken along line 4D-4D of FIG. 4-A;

FIG. 4-E is an enlarged cross sectional view taken along line 4E-4E of FIG. 4-A;

FIG. 5-A is a frontal view of a label holding clamping index tab according to an aspect of the present invention;

FIG. 5-B is a top view of the label holding clamping index tab of FIG. 5-A;

FIG. 5-C is a side elevation view of the label holding clamping index tab of FIG. 5-A, shown in a closed position;

Identical numerals in the drawings represent similar parts throughout the description.

### DETAILED DESCRIPTION

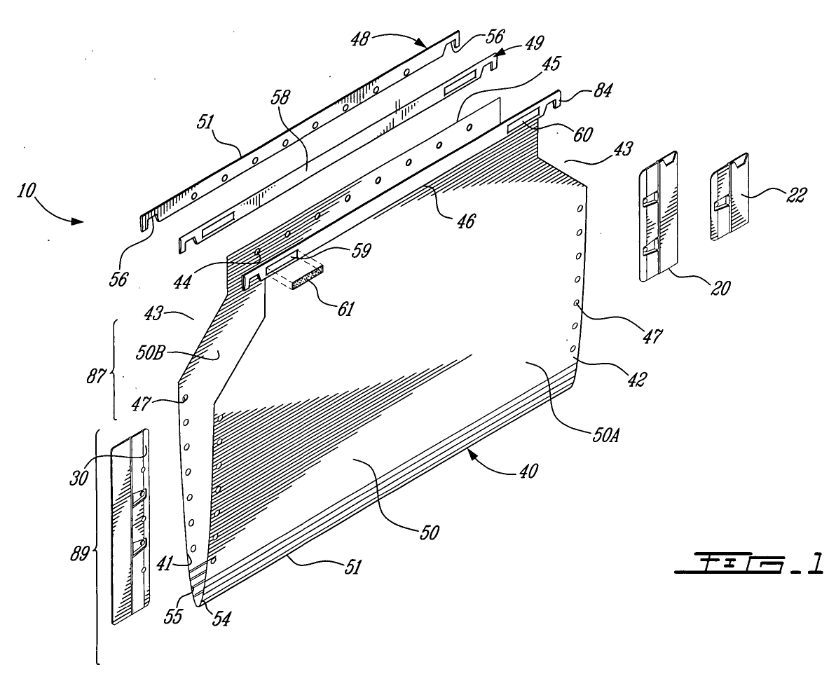

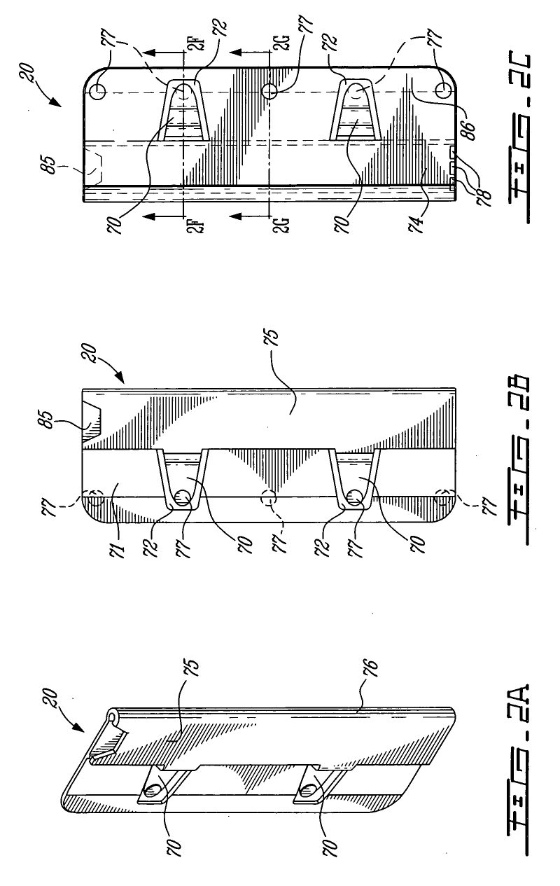

Generally stated, the present invention relates to a suspension-type file folder and index tab system 10. An embodiment of the system is as illustrated in FIG. 1. The system 10 comprises a suspension-type file folder 40, and may comprise label holding clamping index tabs such as 20 (3.5″ long) and 22 (2″ long), and stick-on clamping index tabs such as 30. The system 10 is provided to enable a user to insert and retrieve documents or files in the folder from a side 41, 42 thereof in a side-loading mode of operation, which provides storage space savings and simplifies file cabinet structures. Therefore, index tabs 20, 22, 30 are designed for attachment to either one of sides 41, 42 of folder 40.

Suspension-type file folder 40 comprises a die-cut web 50 made from plastic material, and folded along a medial line 51 to form two covers 50A and 50B. Each cover has a top edge 45 and two longitudinally spaced apart side edges 41 and 42. Moreover, each cover defines a top portion 87 and bottom portion 89, the top portion 87 being about one third of the distance between the median line and the top edge, and the bottom portion 89 being about two thirds of the distance between the median line and the top edge. Polymers such as polypropylene, polyethylene or similar material are contemplated as they are relatively cheap while providing much higher resistance to wear than paper based materials, the side loading operation causing increased solicitation of the bottom 54 of folder 40, mainly in the vicinity of the edges 41, 42. To save on web processing, the polymer web 50 can be made in a single die-cutting operation and necessitates no folded parts nor gluing or fastening. Folding score lines 55 are formed in web 50 to help reduce the folding radius at bottom 54, thus providing a narrower profile to the loaded file folder 40. Cut-outs such as 43, where the bottom portion 89 is longitudinally larger than the top portion 87, are included in the pattern to facilitate the grasping of the files or documents to retrieve them sidewise from the file folder 40. Series of perforations such as 44 along and promixate the top edges 45, 46 and perforations 47 (four series of 7 shown, more may be used for additional flexibility in index tab positioning) along and proximate the bottom portion of the side edges 41, 42 are also provided and can be punched in the same die-cutting operation.

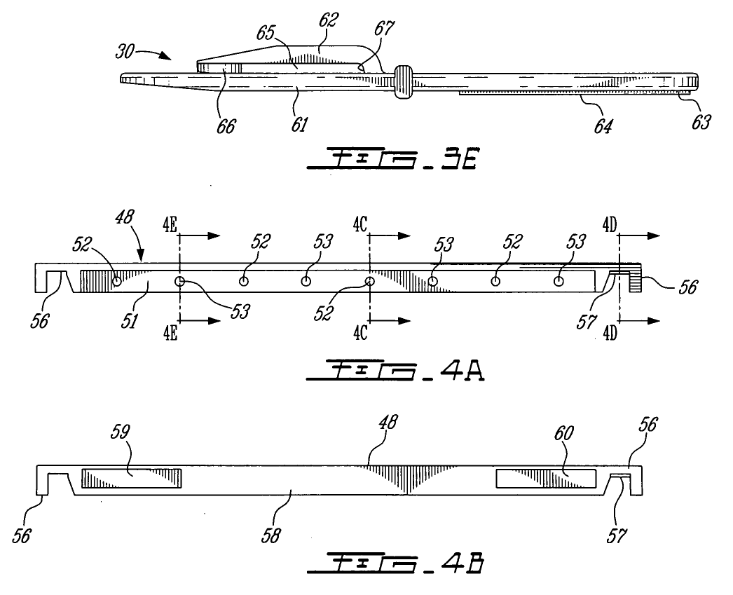

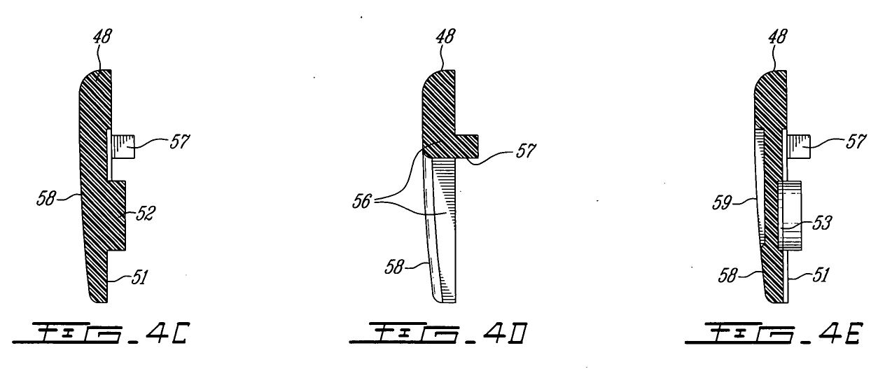

Two rail assemblies are each made with two identical suspension rails such as 48, 49. These rails are assembled face to face by pair at top edges 45 and 46 of the web 50, and are also made from plastic material. The rails sandwich the web 50 as will be described hereinbelow. Since the four suspension rails are identical, they can be obtained from a single mould cavity, generating cost savings and simplifying inventory management. FIG. 4 shows the details of the suspension rail. A high modulus and high hardness polymer such as high impact polystyrene or composite material is preferably contemplated, given the load and wear being supported by this type of product, especially in the vicinity of the suspension hooks 56. As seen from FIG. 4-A, the rail 48 comprises a flat inner face 51 provided with a series of successive pins 52 and recesses 53. A pair of identical rails 48, 49 can thus be assembled about each top edge 45, 46 of web 50 by inserting pins 52 of a first rail through perforations 44 provided in the web 50 to finally nest the pins into matching recesses 53 of the second rail 49, and vice versa (see FIG. 1), thereby sandwiching each top edge 45, 46 of web 50 between two complementary though identical rail members, forming two complete suspension rail assemblies such as 84. Thereby, file folder 40 can be suspended on a pair of transversal metallic suspension bars in a file cabinet, skate portions 57 of hooks 56 resting and gliding on such bars (not shown). To provide optimal mechanical resistance of the assembly, rails 48, 49 may be fuse welded together across cover top edge 45. It is worth mentioning that splitting the rail assembly in two symmetrical halves favors optimal absorption of the load transmitted through the web and prevents bending and twisting of the rail assembly 84. Also, the rail structure remains compatible with the use of existing top mountable label holding index tabs.

In addition, the outer face 58 of rails 48, 49, can be provided with molded cavities 59, 60, wherein a fastening member such as a Velcro™ hook or loop component 61 (see FIG. 1), or a snap fastener component can be assembled. Preferably, a hook or loop component 61 is adhesively assembled in one of the cavities and the complementary component is assembled in the other cavity. Thereby, when two identical rails 48, 49 are applied against one another with their outer face 58 face-to-face, complementary fastener components are mating and provide removable attachment of the two rails. Therefore, such a system enables a user to connect juxtaposed file folders 40 to one another to form a continuous chain of folders on the suspension bars. Cavities 59, 60 are provided for partially nesting the fastener components, leaving only their active portion to emerge, thus minimizing the spacing between suspension bars of adjacent folders.

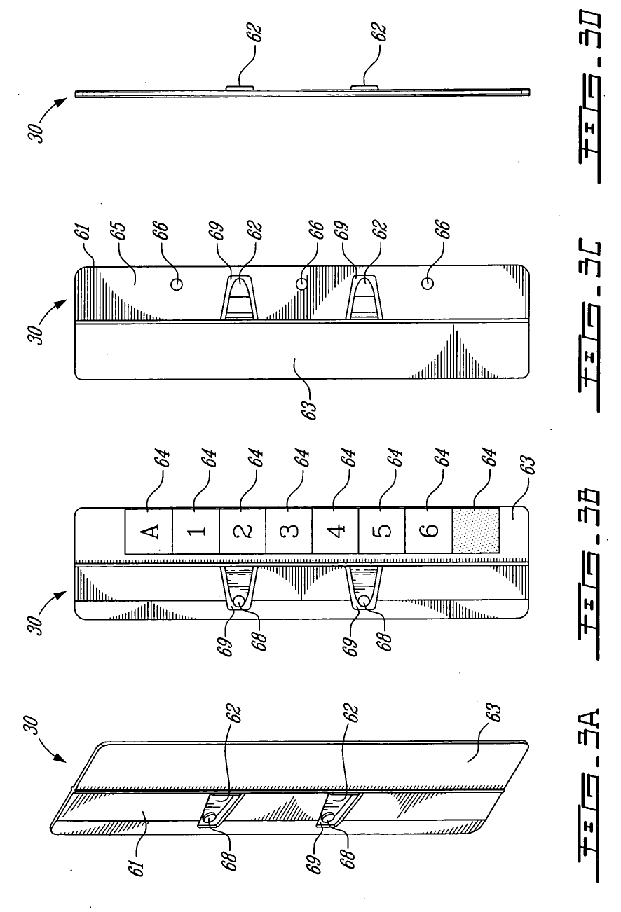

Referring now to FIG. 3, a stick-on index tap 30 for assembly on a side edge 41, 42 of the folder will now be described. Stick-on index tab 30 is designed to be positively but removably mountable on a side such as 41, 42 of covers 50A and 50B of suspension-type file folder 40 using perforations 47, thereby providing front readable index information when file 40 is used in a front-loading filing system.

The stick-on index tab 30 is an injection molded plastic component comprised of a base plate 61, clamping tabs 62 and a flat elongated handle portion 63, which is adapted for application of index information indicia 64 on either face or both faces thereof. For ease of molding, windows 69 are provided in the base plate 61 in register with the clamping tabs 62. The indicia 64 can be supported on a self-adhesive sticker, such as pre-printed chromatic and/or alphanumeric index stickers, that can be applied directly to the handle 63. Alternatively, information indicia can be directly written or marked on the writable substrate faces of handle 63, using an appropriate ink marker or hot stamping device for permanent making. The stick-on index tab 30 is made from semi-rigid compliant plastic material such as polystyrene, polyester, PVC, ABS or the like to provide good adhesive properties and mechanical resistance, as well as some compliance at clamping tabs 62 to enable temporary increase of the gap between its free end and the base plate 61 using a slight force.

The inner face 65 of base plate 61 is provided with a plurality of ridges or pins 66 adapted for insertion in perforations 47 proximate to edges 41, 42 of web 50. Therefore, a user may hold the index tab 30 by its handle portion 63 and slip it over a perforated edge such as 41 of the folder 40, the edge 41 being inserted between the inner face 65 of the plate and the clamping tab 62, forcing the tab 62 to slightly spread apart and apply a clamping force on the web 50. Index tab 30 is placed so that pins or ridges 66 come in register with at least some of the perforations 47 and insert therein, thus providing positive alignment and anchoring of the index tab on a side edge the folder 40. Edges 67 at the base of clamping tabs 62 act as stop members to help the user to roughly align the index tab 30 about the edge 41 at the proper depth for ridge registering, so that complete registering can be achieved through a slight subsequent longitudinal sliding movement of the index tab. Optionally, for more positive anchoring, additional ridges 68 may be provided on the inner face of the free end of clamping tabs 62 to mate with perforations 47. For removal, clamping tabs 62 may be forced open by hand while pulling handle 63 out, up or down, or the ridges (pins) 66, 68 may be rounded or wedge shaped at their apex, so that merely pulling the handle 63 will cause the ridges 66, 68 to slip out of the perforations 47, generating a vertical force component counterbalancing the clamping force of tab 62, forcing it to open, slip on the web 50 and release the index-tab. Outer face of clamping tab 62 is meant to be fastened in inner portion of folder 40, so it is tapered to prevent interference or catching with files or documents when pulling them out.

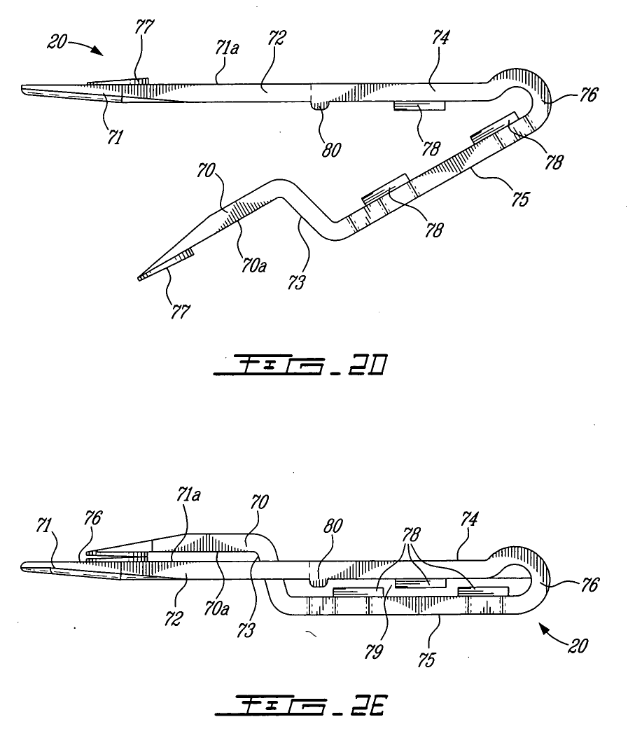

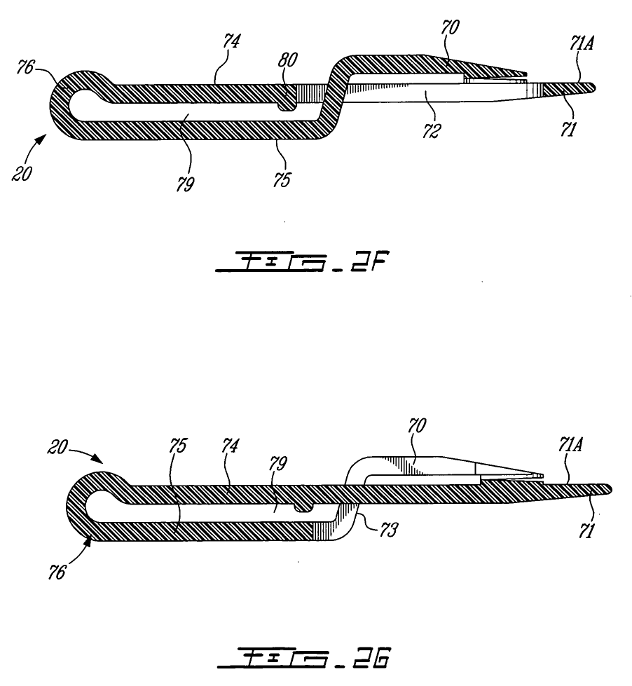

Turning now to FIG. 2, a second type of index tab will be described, also injection molded from an appropriate compliant plastic material. Index tab 20 is configured to hold an index label and for easy attachment and removal at different positions (heights) along side edges 41, 42. Although a 3.5″ long index label holding tab 20 provided with two clamping tabs 70 will be described, it is contemplated that a shorter tab such as tab 22 of 2″ long could be provided to complete the file folder system 10, the tab having a structure similar to that of label holding clamping index tab 20, except for its single clamping tab (see FIG. 1). Obviously, the number and position of the clamping tabs, as well as the length of the index tabs, may be modified at will without departing from the spirit and nature of the invention. These label holding tabs 20, 22 are provided to enable a user to prepare labels bearing index information indicia and have this index information posted at the side end of a file folder 40 facing the front of a cabinet to be laterally readable when used in a side loading filing system.

Index label holding tab 20 comprises a base plate 71 defining a first file contacting surface 71A provided with two windows 72 through which the clamping tabs 70 defining a second file contacting surface 70A and comprising a back stop 73 can be inserted, a lower handle portion 74 extending from the base plate at one end and connected to an upper handle portion 75 through an integral compliant joint 76. Tab 20 may adopt an open configuration as shown in FIG. 2-D or a closed configuration as shown in FIGS. 2-E to 2-G. In the open configuration, upper and lower handle portions are spread apart enabling a user to place an index label on either of inner sides thereof, and then close tab 20 by pressing the handle portions against each other with one hand, counteracting the spring-back force developed in compliant joint 76 and thereby forcing clamping tabs 70 through windows 72 in base 71. In this attitude, tab 20 somehow acts as a tweezer since controlling the squeezing pressure applied on the handle provides control of the spacing between the clamping tab 70 and the base plate 71. More specifically, the spacing between the two file contacting surfaces 70A and 71A. Releasing pressure on the handle yields a clamping force on a web inserted between clamping tabs 70 and the inner face 71A of base plate 71. Therefore, squeezing of the handle portions 74, 75 between the fingers of a hand enables a user to easily clamp tabs 20 or 22 at a selected longitudinal position on an edge 41, 42 of a web 50 or to remove it therefrom. When attached in its closed attitude, a thin elongated cavity 79 is formed between inner faces of handle portions 74, 75, of index tab 20, wherein an index label may be inserted. Accordingly, the walls of the cavity 79 are advantageously transparent to allow the label to be seen therethrough.

As can be seen from FIG. 2E, when closed, the tab 20 has a generally slanted 8-shaped configuration.

It is to be noted that the removable index tab 20 comprises less ridges than the number of perforations provided in a side of the web, whereby the index tab may be selectively attached at a plurality of positions along the edge, removed therefrom and repositioned at will.

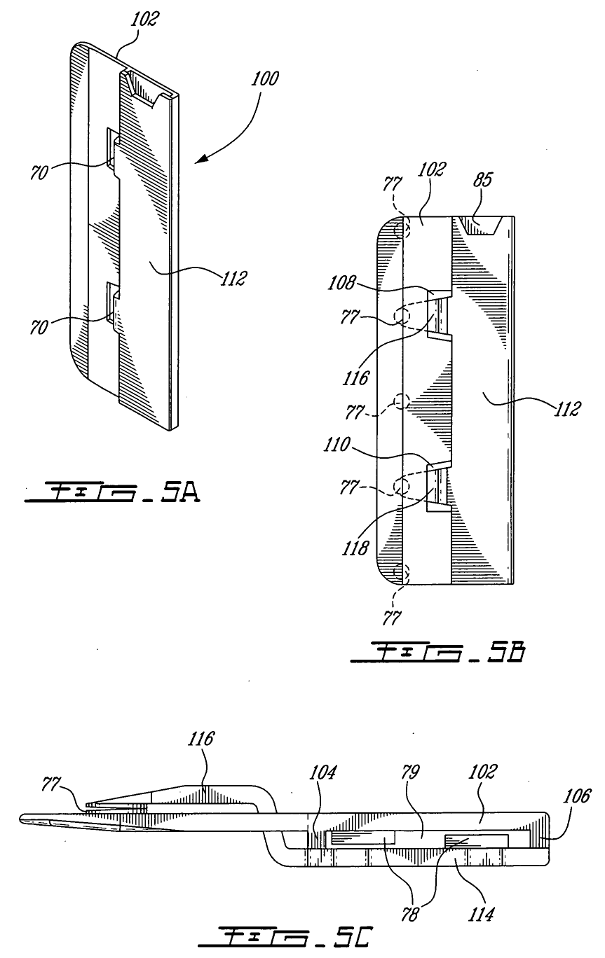

Another embodiment of an index label holding tab 100 is illustrated in FIG. 5. Since the tab 100 is very similar to the holding tab of FIG. 2, only the differences therebetween will be described.

The holding tab 100 is made of two assembled pieces fuse welded together by ultrasound, for the purpose of cutting down on production costs. The first piece 102 has a generally F-shaped cross-section, provided with short longitudinal legs 104 and 106 and provided with two clamp receiving apertures 108 and 110. The second piece 112 has a generally longitudinal flat portion 114 and is provided with two clamping tabs 116, 118 laterally attached thereon. The flat portion 114 is assembled to both legs 104 and 106. The joined first and second pieces define an elongated handle provided with a vertical cavity and a notch 85 to enable users to easily remove an index label inserted into the vertical cavity. The first and second pieces may be joined, for example, by fuse welding.

As contemplated in the foregoing description of stick-on tab 30, the base plates as well as the free ends of clamping tabs 70 are provided with ridges or pins 77 adapted for insertion into some of the perforations 47 proximal to edges 41, 42, thereby providing positive attachment and proper alignment of the tabs 20, 22 and 100. Again, back stop portions 73 in clamping tabs 70 assist the user in rapidly locating the right depth of insertion for attachment of the label holding tabs in the perforations of the web 50 and to align the tab's longitudinal axis with the edge of the file. Tab 20 further comprises stop members 78 at the extremities of the respective inner faces of the lower handle portion 74, and optionally on the upper handle portion 75, to prevent slipping of the label out of the cavity 79 formed between closed handle portions, under the effect of the gravity, once the tab 20 is positioned in a vertical attitude on edge 41. Lateral movement of the label in cavity 79 is limited by the handle joint edge 76 on one side and by an elongated longitudinal ridge 80. A notch 85 is further provided at a lateral edge of upper handle portion 75 to enable a user to easily remove an index label inserted into cavity 79, using a sharp object or his nails, without having to unclamp and open the label holding tab 20. It is worth pointing out that index label holding tabs 20, 22 and 100 are so dimensioned to comply with the size of most currently existing tabs and labels in the field. Therefore, the label holding tabs of the present invention advantageously enable a user to convert a top loading file system to a side loading type, while reusing his already prepared index labels, yielding substantial time and money savings.

One can thus easily appreciate that the above described embodiments according embodiments and aspects to the present invention provide effective solutions for reducing wear effects on suspension-type file folders and providing removable and adjustable front readable index tabs for side loading filing systems. Therefore, it can be seen that the suspension-type file folder and index tab system can be advantageously used in miscellaneous filing applications.

Although the present invention has been described hereinabove by way of preferred embodiments thereof, it can be modified, without departing from the spirit and nature of the subject invention as defined in the appended claims.

What is claimed is:

1. A suspension-type file folder comprising:
a web, folded along a medial line to form two attached covers, each cover having a top edge and two longitudinally spaced apart side edges; each cover defining a bottom portion and a top portion; the bottom portion being longitudinally larger than the top portion; a series of perforations are provided through the web along and proximate the bottom portion of at least one of the two side edges; and
two longitudinally elongated flat suspension rail assemblies, one of the rail assembly being mounted to the top edge of the first cover, and the other rail assembly being mounted to the top edge of the second cover;
wherein the difference in longitudinal size between the top and bottom portions of the covers offers an opening on the top portion such that a side loading mode of inserting and retrieving documents to and from the suspension-type file folder can be achieved.

2. A suspension-type folder as defined in claim 1, further comprising a series of perforations provided through the web along and proximate each one of the top edges.

3. A suspension-type file folder as defined in claim 1, wherein each elongated flat suspension rail assembly includes first and second rails, the first and second rails being so mounted to a respective top edge of one of the first and second covers as to sandwich the cover therebetween.

4. A suspension-type file folder as defined in claim 3, wherein said first and second rails are identical.

5. A suspension-type file folder as defined in claim 3, wherein
the first rail includes first pins and first recesses; and
the second rail includes second pins and second recesses;
wherein, when the first and second rails are mounted to the top edge of one cover, a) the first pins are inserted through some of the perforations on the top edge and mate with the second recesses and b) the second pins are inserted through some other of the perforations on the top edge and mate with the first recesses.

6. A suspension-type file folder as defined in claim 3, wherein the rails are further provided with fastening members to interconnect the suspension-type file folder to and adjacent suspension-type file folder.

7. A suspension-type file folder as defined in claim 6, wherein the fastening members include hook and loop fasteners.

8. A suspension-type file folder as defined in claim 4, wherein the rails are made from plastic material and are assembled together via fuse welding.

9. A suspension-type file folder defined in claim 8, wherein the plastic material is selected from the group consisting of high modulus polymer, high hardness polymer, high impact polystyrene and composite material.

10. A suspension-type file folder as defined in claim 1, further comprising an index tab removably attached to one of the side edges, via some of the perforations provided therein, thereby allowing the index tab to be positioned to a desired position thereon.

11. A suspension-type file folder as defined in claim 1, wherein the bottom portion is defined from the median line to about two thirds of the distance between the median line and the top edge.

12. A suspension-type file folder as defined in claim 1, wherein the top portion is defined from the top edge to about one third of the distance between the median line and the top edge.

13. A suspension-type file folder as defined in claim 1, wherein the web is made of plastic material.

14. A suspension-type file folder as defined in claim 13, wherein the plastic material is selected from the group consisting of polypropylene and polyethylene.

15. A removable index tab, for suspension-type file folders provided with an edge having perforations, the removable index tab comprising:
a longitudinal base plate, having a first file contacting surface; and
at least one clamping tab having a second file contacting surface; the at least one clamping tab being so associated with the longitudinal base plate that the second file contacting surface faces the first file contacting surface; at least one of the first and second file contacting surfaces being provided with at least one ridge so configured and sized as to enter perforations of the file folder, thus providing positive attachment of the removable index tab onto the suspension-type file folder.

16. A removable index tab as defined in claim 15, wherein the at least one clamping tab includes at least two clamping tabs.

17. A removable index tab as defined in claim 15, wherein the at least one ridge includes at least one pin.

18. A removable index tab as defined in claim 15, further comprising an elongated handle extending laterally from the longitudinal base plate.

19. A removable index tab as defined in claim 15, wherein the elongated handle includes:
an elongated cavity to hold an index label;
a notch to allow removal of an index label; and
a stop to prevent slippage of the index label.

20. A removable index tab as defined in claim 18, wherein the elongated handle and the longitudinal base plate are integrally formed and connected to each other through an integral compliant joint which acts as a spring, the compliant joint allowing an open configuration when the index tab is not mounted to a file and a closed configuration when the index tab is mounted to a file.

21. A removable index tab as defined in claim 20, wherein the index tab generally defines a slanted 8-shape when in the closed configuration.

22. A removable index tab as defined in claim 18, wherein indexing information indicia can be applied to the elongated handle.

23. A removable index tab as defined in claim 15, wherein the at least one clamping tab comprises a back stop portion to contact an edge of the suspension-type file folder when the at lease one ridge enters a perforation thereof.

24. A removable index tab as defined in claim 18, wherein the index tab is made of two pieces; a generally flat first piece having a generally F-shaped cross-section defining two longitudinal legs and provided a clamp receiving aperture; and a second piece having a generally longitudinal flat portion and provided with the at least one clamping tab laterally attached thereon; the flat portion being assembled to both legs of the F-shaped first piece.

25. A removable index tab as defined in claim 24, wherein the first and second pieces are made of plastic material and are fuse welded together.

26. A removable index tab as defined in claim 15, wherein the index tab is made of plastic material.
